(19) United States
(12) Patent Application Publication
(10) Pub. No.: US 2002/0169597 A1
(43) Pub. Date: Nov. 14, 2002

(54) Method and apparatus providing computer understanding and instructions from natural language

(75) Inventors: Vitaliy S. Fain, Worcester, MA (US); Samuel V. Fain, Brookline, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Fain systems, Inc., Woburn, MA

(21) Appl. No.: 10/043,998

(22) Filed: Jan. 11, 2002

Related U.S. Application Data
(60) Provisional application No. 60/274,786, filed on Mar. 12, 2001.

(51) Int. Cl. G06F 17/27

(52) U.S. Cl. 704/9

(57) ABSTRACT

Computer understanding and generation of computer instructions from natural language dialog utilizes using processes and data structures that map natural language utterances to computer program modules. A series of dictionaries, including a subject area dictionary, a program module subdictionary, an argument subdictionary and a value subdictionary are built and used by a computer instruction generator program to map natural language utterances to computer instructions. Selection of appropriate computer program modules is performed using matching algorithms and is enhanced using historically successful probability-based data.

### RELATED APPLICATION

This application claims the benefit of U.S. Provisional Application No. 60/274,786, filed on Mar. 12, 2001. The entire teaching of the above application is incorporated herein by reference.

### BACKGROUND

Computer language processing systems lack an effective way of providing computer understanding and generating computer instructions from natural language dialog. Computer language processing systems generally fall into two categories: dictation systems and command systems. Dictation systems (e.g., IBM ViaVoice and Dragon Systems Naturally Speaking) provide speech recognition and translation to text capabilities. These systems usually work in conjunction with a word processing program to allow a user to dictate text into an electronic document. Command systems also utilize speech recognition and in addition attempt to map elements of the speech to known computer commands. For example, instead of using a keyboard or mouse to choose a File Open command, users of command systems can speak the phrase, “File Open” and the combination of the speech recognition and command systems can map the utterance to a File Open command on the computer.

Current computer language recognition systems suffer from an inability to accurately translate continuous speech, especially when attempting to do so in a speaker independent fashion. Additionally, the associated command systems often restrict the user to a rigid, menu-based or form-based template language that is anything but natural and do little to provide understanding of the users' natural language.

### SUMMARY

Understanding of computer users' natural language dialog provides for improved effectiveness and efficiency of computer applications. When computer users can interact with a computer system without the need for hand-based input devices (e.g., keyboard, mouse or pen) they are free to use their hands to perform other tasks. This freedom allows computer applications to be applied to domains where they might not otherwise be applied before “hands-free” computing was possible. But simply translating computer users' speech into text is only part of the solution. In order to control computer applications, the speech must be “understood” by the computer. The fact that most computer users prefer to speak in a continuous, natural language manner and the fact that computers currently only understand highly structured input create a problem. Particular embodiments of the present invention overcome this problem to provide computer understanding by generating computer instructions from a natural language dialog. A dialog is defined as a series of natural language utterances between a computer user and a computer.

A natural language utterance is said to be understood by the computer if the computer responds to it with an adequate (expected by the user) response. That is, if the response can be correctly determined from: the contents of the natural language utterance, the current context and the environment, and therefore a proper subject-area, sub-subarea, program module, its argument and the values of the arguments required to form a complete computer language instruction are selected. Particular embodiments of the present invention provide for the construction of subject areas, and sub-subject areas, from real world domains (e.g., petroleum trading, automobile sales, dentistry practice, etc.) in order to facilitate training the computer to understand natural language utterances related to a particular domain. Each subject area, or sub-subject area, has program modules associated with it. The program modules know how to perform a unit of work on the computer. Each program module has a set of input arguments that must be supplied and a set of values (or constraints) for those arguments. The present invention maps a natural language utterance to a particular program module, and thus to a set of computer instructions in order for the computer to understand and respond to the natural language utterance.

Embodiments of the present invention can include a system and method for providing computer understanding by generating computer instructions from a natural language dialog. The system can first receive a symbolic representation of a natural language utterance. By accessing a context sensitive system dictionary for a subject area, a subject area identifier can be determined based upon parsing the symbolic representation, the parsing producing parsed information. A module identifier based upon the determined subject area identifier and the parsed information can be determined by accessing a context sensitive system dictionary for program modules of the subject area. Further, an argument identifier based upon the determined module identifier and the parsed information can be determined by accessing a context sensitive system dictionary for arguments of the program module. A value identifier based upon the determined argument identifier and the parsed information can then be determined, by accessing a context sensitive system dictionary for values of the argument. Finally, computer instructions based upon the subject area identifier, the module identifier, the argument identifier and the value identifier can be produced such that the natural language utterance is processed by the computer. Each subject area context sensitive system dictionary can be broken down into sub-subject area dictionaries. Once parsed, missing identifiers can be supplied by querying the computer system itself, querying the user and/or determining the missing identifier using a previously determined value for the missing identifier.

In one particular embodiment, a probabilities-based method can be used to determine an appropriate program module selection for processing a natural language dialog in a computer system for processing natural language. A set of successfully understood natural language dialogs and associated program modules used to produce computer understanding can be captured. The captured program module information can be analyzed to determine a frequency of occurrence value for proceeding to a next program module from a current program module. The frequency of occurrence values can be stored in a matrix. Using the matrix, the appropriate program module selection can be determined, based on choosing program modules having non-zero frequency value entries in the matrix. Further, the step within the natural language dialogs associated with specific program modules can be captured and used to determine appropriate program module selection based on choosing program modules with matching step information. Groupings of the program modules can also be used to determine appropriate program module selection based on choosing certain program module groups.

Embodiments and applications of the present invention can provide scalable change, so that as the domain vocabulary grows, the application can be modified in a commensurate manner to accommodate the changes. Scalability is a significant benefit of the system. Conventional computer language processing systems can require major upgrading, even for a minor change in the language domain.

Applications of the present invention can also be reusable, based upon the component nature of the various dictionaries defined. Dictionary reuse can lead to faster development of new applications at a lower cost.

### BRIEF DESCRIPTION OF THE DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a computer system on which an embodiment of the present invention is implemented.

FIG. 2 shows the internal structure of a computer of FIG. 1.

FIG. 3 illustrates a conceptual view of the relationship between subject areas, sub-subject areas, program modules, arguments and values, as provided in an embodiment of the present invention.

FIG. 4 is a flowchart of the training process as provided in an embodiment of the present invention.

FIG. 5 is a flowchart of the process of providing computer understanding by generating computer instructions from a natural language dialog as implemented in an embodiment of the present invention.

FIGS. 6a, 6b and 6c are illustrations of example program modules with certain values undetermined.

### DETAILED DESCRIPTION

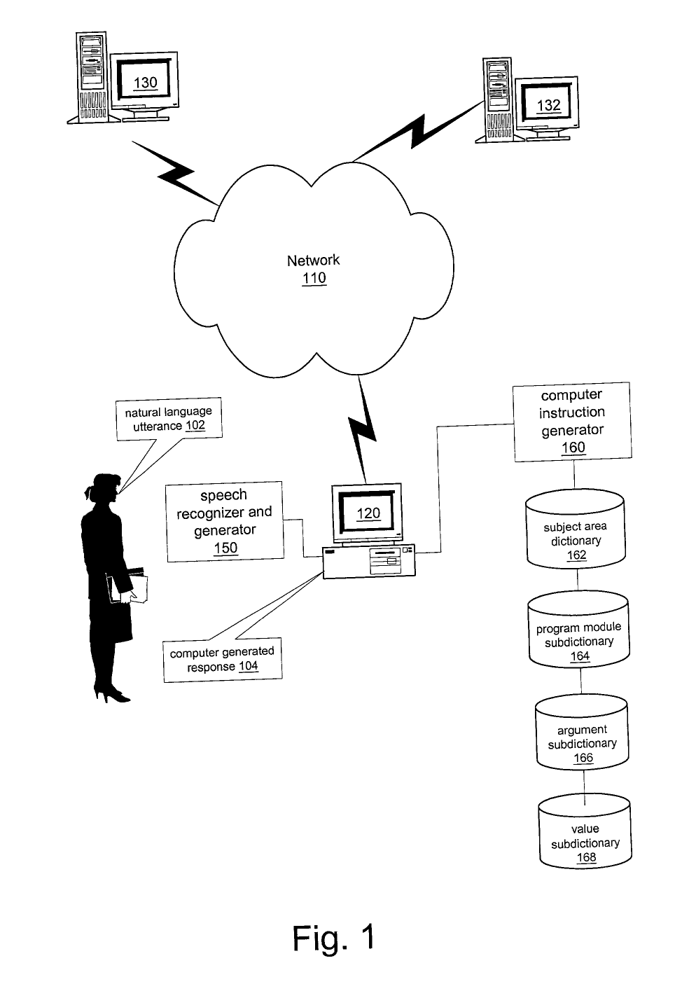

FIG. 1 illustrates a computer network 110 on which an embodiment of the present invention can be implemented. A client computer 120 provides processing, storage, and input/output devices for providing computer understanding by generating computer instructions from a natural language dialog. The client computer 120 is also linked to a communications network 110 having access to other computing devices, including server computers 130 and 132. The communications network 110 can be part of the Internet, a worldwide collection of computers, networks and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. In another embodiment of the present invention, the processing, storage, and input/output devices for providing computer understanding by generating computer instructions from a natural language dialog can be contained on a stand-alone computer.

A client computer 120 provides speech recognition hardware (e.g., microphone) and a speech recognizer and generator 150 for accepting natural language utterances 102 and providing computer generated responses 104. The speech recognizer and generator 150 provides the input and output processing for a user/computer dialog. The information for the content of that dialog is produced by a computer instruction generator 160. The computer instruction generator 160 receives a symbolic representation of a natural language utterance 102, and using the various dictionaries (subject area dictionary 162, program module subdictionary 164, argument subdictionary 166, and value subdictionary 168), determines a computer understanding of the natural language utterance 102. The computer understanding manifests itself in a set of generated computer instructions for accomplishing the expected computer generated response 104. The computer generated response 104 can comprise any conputer generated result, including calculations, textual and graphical representations, and the like. The computer generated response 104 can also comprise computer generated utterances. In this case, the results of the executed computer generated instructions are then processed by the speech recognizer and generator 150 such that a computer generated response 104 is delivered to the user as spoken language. Continued iterations of a natural language utterance 102, processing by the speech recognizer and generator 150 and the computer instruction generator 160, coupled with the computer generated responses 104, define the dialog and computer understanding of an embodiment of the present invention.

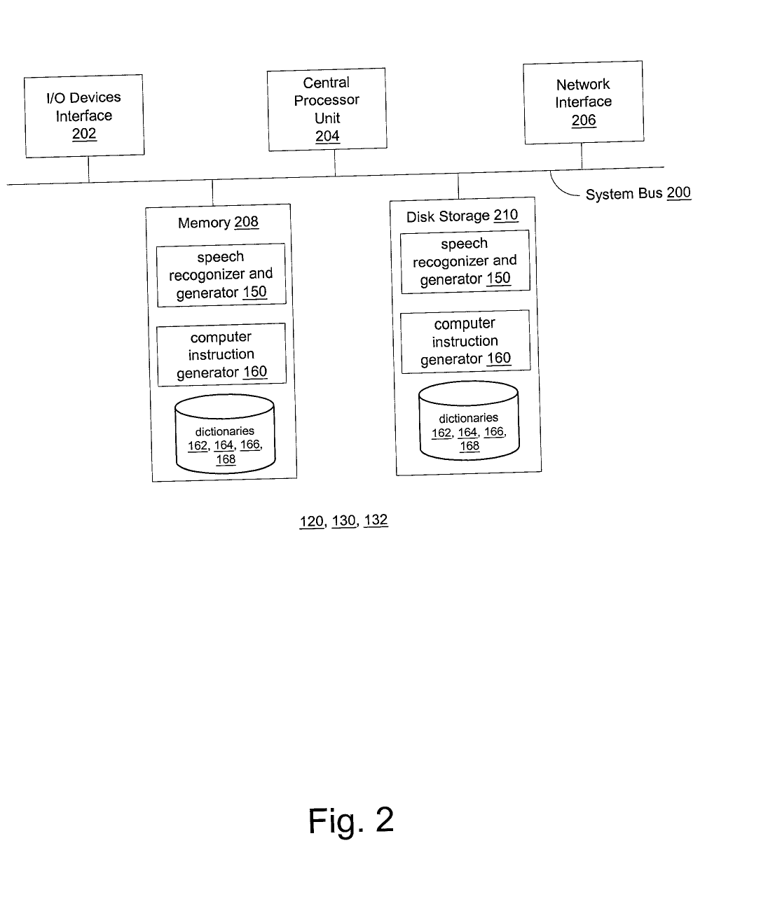

FIG. 2 shows the internal structure of a computer (e.g., 120, 130, 132) in the computer network 110 of FIG. 1. Each computer contains a system bus 200, where a bus is a set of hardware lines used for data transfer among the components of a computer. A bus 200 is essentially a shared conduit that connects different elements of a computer system (e.g., processor, disk storage, memory, input/output ports, network ports, etc.) that enables the transfer of information between the elements. Attached to system bus 200 is an I/O device interface 202 for connecting various input and output devices (e.g., microphone, plotters, displays, speakers, etc.) to the computer. A network interface 206 allows the computer to connect to various other devices attached to a network (e.g., network 110). A memory 208 provides volatile storage for computer software instructions (e.g., speech recognizer and generator 150 and computer instruction generator 160) and data structures (e.g., dictionaries 162, 164, 166 and 168) used to implement an embodiment of the present invention. Disk storage 210 provides non-volatile storage for computer software instructions (e.g., speech recognizer and generator 150 and computer instruction generator 160) and data structures (e.g., dictionaries 162, 164, 166 and 168) used to implement an embodiment of the present invention.

A central processor unit 204 is also attached to the system bus 200 and provides for the execution of computer instructions (e.g., speech recognizer and generator 150, computer instruction generator 160 and generated computer instructions), thus allowing the computer to providing computer understanding by executing computer instructions generated from a natural language dialog.

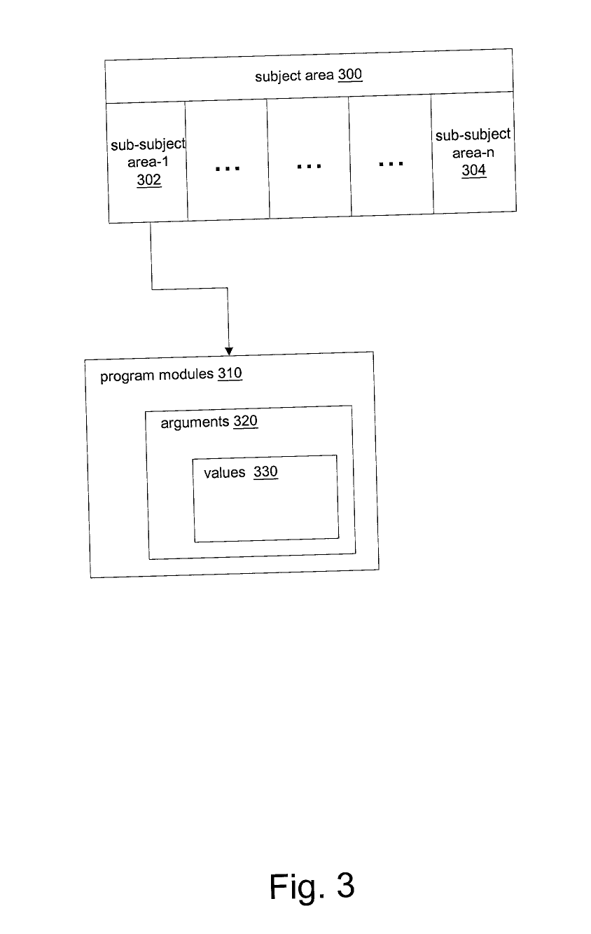

FIG. 3 illustrates the logical organization of the data structures defined by an embodiment of the present invention, including a conceptual view of the relationship between subject areas, sub-subject areas, program modules, arguments and values, as provided in an embodiment of the present invention. Each subject area for which computer understanding is desired is defined by a subject area 300 data structure. Subject areas 300 are used to recognize terms in the natural language utterance 102 in order to determine the domain (subject area 300) to which the natural language utterance 102 belongs. Various matching techniques can be used to match natural language utterance 102 terms to terms stored in that subject area dictionary 162. In one particular embodiment, an “optimal inverse method” of matching can be used. The “optimal inverse method” is described in U.S. Provisional Application No. 60/274,786, filed on Mar. 12, 2001 and titled “Method Of Speaker Independent Computer Understanding Of Usual Continuous Oral Speech With Very High Reliability”.

The subject area 300 data structures can be organized into sub-subject areas. These are defined by sub-subject area-1 data structure 302 through sub-subject area-n data structure 304. The sub-subject areas 302, 304 allow domains to be broken down into smaller, more manageable units. The sub-subject areas 302, 304 are operated on in a similar manner as are the subject areas 300. The sub-subject areas can provide more accurate domain recognition and more efficient match processing.

Within a subject area 300 (or sub-subject area-1 data structure 302 through sub-subject area-n data structure 304) program modules 310 are defined. The program modules 310 represent units of work that can be executed on the computer. For example, the program modules 310 can be predefined computer commands, or scripts provided by various operating system utilities or application programs installed on the computer system which is the target of the natural language utterance 102 (e.g., client computer 120). The program modules 310 can also be stored on server computers (e.g., server computers 130 and 132) connected to a client computer 120 via a communications network (e.g., network 110).

Each of the program modules 310 can optionally receive inputs and send outputs (program module arguments) to further direct or augment the processing of program modules 310. The program arguments 320 are defined using the standard data structures of the implementation language (e.g., Microsoft Visual Basic, C++, etc.). A given natural language utterance may evoke the execution of one or more of the program modules 310.

Each program argument 320 has a set of valid values 330 that it will accept as input and/or validate as output. Certain program arguments 320 can be defined to accept/validate a range of values (e.g., integers between 1 and 100, alpha-numeric strings, etc.). The combination of the program modules 310, the program arguments 320 and the values 330 provide for a rich definition mechanism for mapping the natural language utterances 102 to sets of computer executable instructions. Executing these computer instructions provides an ability to produce the user expected reaction, for example a computer generated response 104, thus creating a dialog in which the computer can provide computer understanding of the natural language utterances 102.

The following is an example set of dictionary entries for various domains (subject areas 300, sub-subject areas 302, 304). The italicized items indicate various predefined elements, the quoted items indicate example terms within the predefined element. The main example defines an automobile dealership domain.

Subject Area 300:

Automobiles:

“car”, “vehicle”, “truck”, “SUV”, “transportation”

Sub-subject Area 302, 304:

Sales: “buy”, “purchase”, “sell”, “trade”, “how much”, “cost”

Service: “fix”, “repair”, “warranty”, “ready”

Financing: “loan”, “lease”, “interest rate”, “down payment”

Oil Refining: “refinery”, “pipeline”, “gasoline”, “oil”, “crude”, “fuel”

Dentistry: “tooth”, “cleaning”, “extraction”, “x-ray”, “crown”, “ache”

Program Modules 310:

Sales:

DisplayPrice ( ): “how much”, “cost”

SubmitOffer ( ): “how about”, “will you take”,

CheckStatus ( ): “ready”, “OK to pick-up”

Service:

CheckStatus ( ): “ready”, “OK to pick-up”, “done”

Financing:

ObtainFinancingQuote ( ): “whats the rate”, “what's the monthly cost”

Arguments 320:

DisplayPrice (Sub-subjectArea, Vehicleld, Price)

SubmitOffer (Sub-subjectArea, PurchaserId, VehicleId, Offer)

CheckStatus (Sub-subjectArea, PurchaserId, VehicleId)

ObtainFinancingQuote (PurchaserId, Vehicleld, Terms)

Argument Values 330:

PurchaserId: string

VehicleId: “Explorer”, “Jeep”, “Chrokee”, “BMW 740il”, “VWBeetle”, “bug”, “SUV”, “Hummer”, “Humvee”,

Offer/Price: numeric

Using the defined domain structure above, natural language utterances such as:

“Is my car ready?”

“How much is an Explorer?”

“Give me the next appointment with the doctor”

“What's the rate on a loan for that?”

“Will you take $32,500?”

“What's the flow rate of the main pipe?”

can be understood by the computer and appropriate responses can be generated. For example, the natural language utterance 102, “Is my car ready?”, will be matched to subject area 300 for Automobiles based upon matching the term “car” in the natural language utterance 102 to the term “car” in the subject area 300 for Automobiles. The term “ready” will further define the sub-subject area as Service. The term “ready” can be used again to identify the specific program module 310 (i.e., CheckStatus) to execute in order to respond to the query. Because CheckStatus is defined to take arguments 320 for Sub-subjectArea, PurchaserId and VehicleId the present invention must provide values for the defined arguments 320. The present invention maintains a context state and stores the current Sub-subjectArea (i.e., Service) and passes Service as the first argument 320 of the program module 310. Additionally, a previous process (possibly a natural language utterance 102 processing mechanism) would have identified and stored a user/purchaser identifier and thus a value for PurchaserId (i.e., “1234”) can be determined. VehicleId (i.e., “Explorer”) can be determined by matching the identified PurchaserId with the PurchaserId of service records in a services database. With a program module 310 and properly defined program argument values 330 identified, a mapping of the natural language utterance 102 is complete. The client computer 120, having understood the spoken utterance, can now execute the instructions of the program module 310 (e.g., CheckStatus (“Service”, 1234, “Explorer”)) to satisfy the request. The results produced by the program module 310 can be displayed to the user and/or provided as a computer generated response 104 using the speech recoguizer and generator 150.

In many conventional “natural” language processing systems the end-user must be trained in the exact syntax of the computer program commands, their arguments and the permissible values. In this case, the “understanding” would be reduced to a standard speech recognition system coupled to an standard interface to the computer program commands (e.g., an Application Programming Interface or “API”). For example, when the end-user wanted to query the computer system for the price of a Ford Explorer the “natural” language utterance required would be “begin-command, display price, left-parenthesis, Explorer, right parenthesis, end-command”. The end-user would be required to target her command to computer program commands within a known subject area and would have to understand the arguments and their values, as well as the exact syntax for generating the computer instructions. This conventional approach assumes that the end-user knows the structure and computer implementation of the domain well, and that the end-user is comfortable using this rigorous model. In contrast, a user of the present invention is not required to know the structure and computer implementation of the domain in order to present their natural language utterance and receive the computer systems' anticipated computer generated response, in particular a natural language response. The present invention maintains a structure (subject area 300, sub-subject area-1 302 through sub-subject area-n 304, program modules 310, arguments 320, and values 330) and computer implementation of the domain (computer instruction generator 160). The present invention is “trained” by populating the structures with data obtained from studying domain-specific conversations of end-users interacting within the domain.

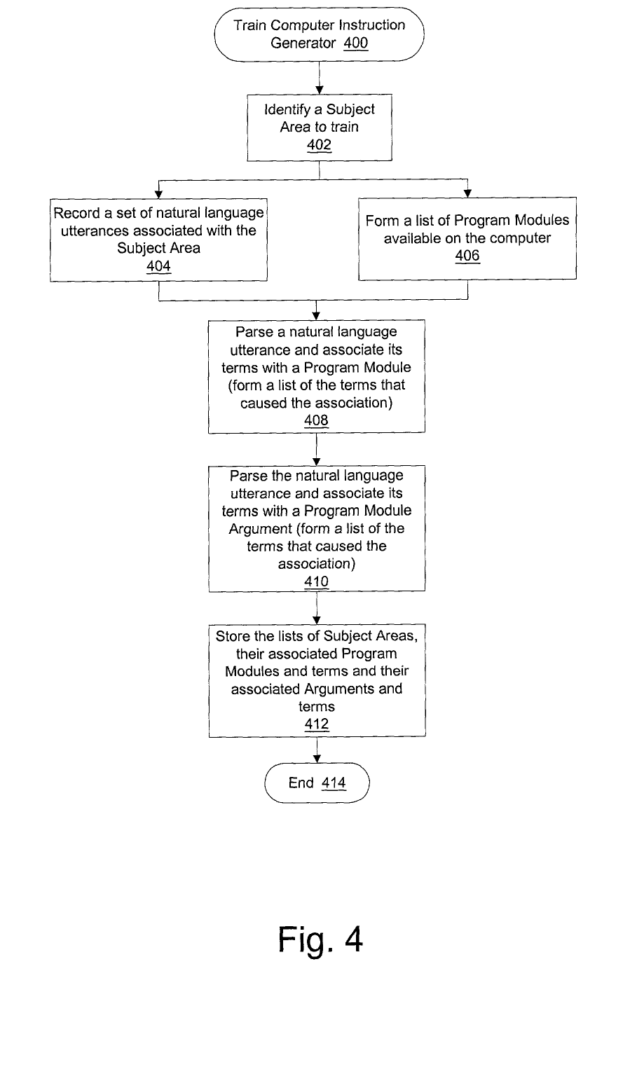

FIG. 4 is a flowchart of the training process as provided in an embodiment of the present invention. Using the training process, a human builds a structured data hierarchy of a domain and its related computer-related components. The training process is used to capture all practically possible natural language naming variants for all subdictionaries involved in the domain (e.g., subject area identifiers, sub-subject area identifiers, program module identifiers, argument identifiers and value identifiers). The result of the training process is a structured set of all identified natural language terms and their mapping to dictionary identifiers.

The process of training of computer instruction generator 160 begins at step 400 and comprises populating its associated data structures. Starting with the highest level, a subject area for which to train is identified (step 402). In step 404 a set of natural language utterances associated with the subject area 300 are recorded. In parallel, or optionally serially, a list of program modules 310 available on the client computer 120 or available as part of the network 110 of server computers 130, 132 is formed (step 406). The program modules 310 having defined arguments 320.

The set of recorded natural language utterances 102 is parsed to form a list of terms used to associate the natural language utterances with the subject area 300. Additionally, the parsing process can identify groupings of terms that logically define a sub-subject area 302, 304 of the identified subject area 300. The program modules 310 that can be used to execute computer instruction to manipulate stored data and/or answer queries associated with the identified subject area 300 and the sub-subject areas 302, 304 are also identified (step 408).

The list of program modules 310 (and their defined program module arguments 320) along with the set of recorded natural language utterances is then parsed to obtain a list of terms associated with the defined program module arguments (step 410). As with the list of terms associated with the program modules 310, the list of terms associated with the program module arguments 320 allows the computer instruction generator 160 to map natural language utterance 102 terms to predefined computer elements (e.g., program modules 310). In this way a user's natural language utterance 102 can be understood by the client computer 120 and processing of it can produce appropriate computer instructions.

The process of training the computer instruction generator 160 is an iterative process producing lists of subject areas 300, sub-subject areas 302, 304, program modules 310, program module arguments 320 and program module argument values 330. At a certain point the lists are stored into data structures stored in memory 208 and/or disk storage 210 that form a hierarchical set of dictionaries 162, 164, 166, 168 used by computer instruction generator 160 (step 412). The process of training of computer instruction generator 160 ends at step 414.

The parsing can occur in multiple, separate steps to obtain the lists of program modules 310, arguments 320 and values 330, or a single-pass parsing can be implemented to obtain all the lists simultaneously.

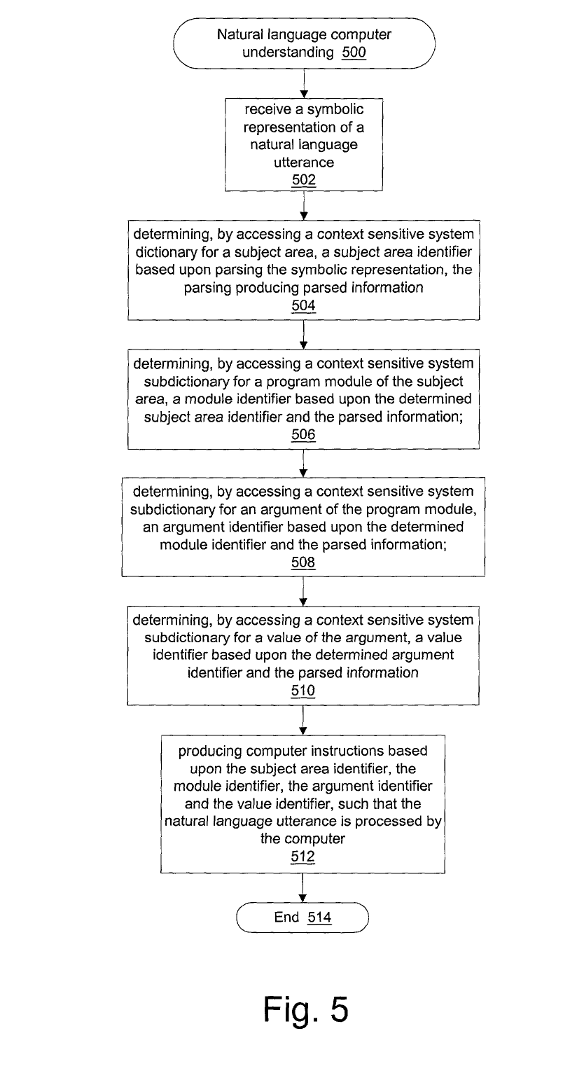

FIG. 5 is a flowchart of the process of providing computer understanding by generating computer instructions from a natural language dialog as implemented in an embodiment of the present invention. The flowchart starts at step 500 and illustrates a method for providing computer understanding by generating computer instructions from a natural language dialog. Initially, a symbolic representation of a natural language utterance is received at step 502. A subject area identifier is determined by parsing the symbolic representation and by accessing a context sensitive system dictionary for a subject area (step 504). A module identifier is determined from the parsed information and by accessing a context sensitive system subdictionary for a program module of the subject area (step 506). An argument identifier is determined from the parsed information and by accessing a context sensitive system subdictionary for an argument of the program module (step 508). A value identifier is determined from the parsed information and by accessing a context sensitive system subdictionary for a value of the argument (step 510). Finally, at step 512, computer instructions are produced based upon the subject area identifier, module, the module identifier, the argument identifier and the value identifier, such that the natural language utterance is processed and understood by the computer. The process of providing computer understanding by generating computer instructions from a natural language dialog ends at step 514.

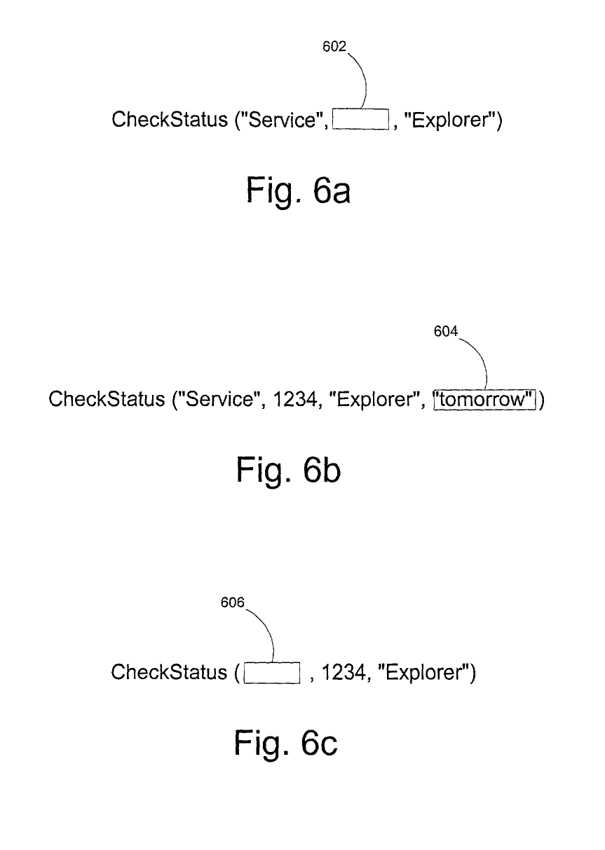

FIGS. 6a, 6b and 6c are illustrations of example program modules with certain values undetermined. Undetermined values occur when the natural language computer understanding process (see FIG. 5) is unable to map a program argument value 330 to a term. In one particular embodiment of the present invention, the computer instruction generator 160 can obtain the undetermined values by asking the user, by querying the computer system and/or by using previously determined (context) information. FIG. 6a illustrates a particular program module 310 (CheckStatus) with a missing (undetermined) PurchaserId 602. In this case computer instruction generator 160 invokes the speech recognizer and generator 150 to issue a query to the user (e.g., “Would you please remind me of your name?”). The user can supply a natural language utterance 102 in response to the query, and the speech recognizer and generator 150 and the computer instruction generator 160 will “understand” the response. Using the information from the user's response, the missing program argument value 330 (PurchaserId 602) can be supplied to the CheckStatus program module. In this way, undetermined values can be supplied by the user.

In another particular embodiment of the present invention, the computer instruction generator 160 can obtain the undetermined values by querying other computer system utilities executing on the client computer 120 (or accessible over the network 110 to a client computer 120). These computer systems may provide standard look-up type data (e.g., state abbreviation codes), or they can provide computer environmental data (e.g., date/time information). In FIG. 6b a fourth program argument 604 has been added for providing a “due date”, in this case “tomorrow”. Here, the user (#1234) is asking the Service department if her Explorer will be ready tomorrow. The computer instruction generator 160 will invoke existing computer system utilities to translate “tomorrow” into the correct date for passing as the program module argument value 330.

In yet another particular embodiment of the present invention, the computer instruction generator 160 can obtain the undetermined values by querying its own context information. Certain natural language utterances 102 will be ambiguous without further context information, for example, if the user asks “And how soon will you have it ready for me?” she may be referring to the purchase of a new car or the repairs on her current car. Since the computer instruction generator 160 monitors context information for subject areas 300, sub-subject areas 302, 304 and program modules 310 it can determine that the last natural language utterance concerned service and can therefore supply Service as the sub-subject area program module argument value 606. Additionally, a context-based value of “it” (i.e., “Explorer”), can also be supplied. In this way ambiguous queries can be processed with reasonable accuracy based on previous context.

Program module selection is performed by parsing the natural language utterance 102 dialog for terms that match known (trained) terms for the subject areas 300, the sub-subject areas 302, 304 and the program modules 310. Theses terms are stored in the subject area dictionary 162 and the program module subdictionary 164, respectively. The selection of program modules 310 is enhanced by applying probability-based information regarding previously selected program modules 310. Knowing which of the program modules 310 have a statistically higher probability of following a specific program module 310 allows embodiments of the present invention to more quickly and reliably choose the best match of a program module 310 to the natural language utterance 102.

The present invention utilizes Markov chains (matrix) to specify the transitional probabilities of a system changing from one given state to another state. Specifically, the Markov chains map the probability that a given program module m will be chosen given that a previous program module m-1 had been chosen.

A simple Markov model is constructed using the following steps:

a) a set of natural language utterance 102 dialogs that were considered to have been successfully understood by the client computer 120 are selected;

b) the set of all program modules 310 used to implement those natural language utterance 102 dialogs is identified, each program module 310 is given a number m;

c) the set of natural language utterance 102 dialogs is analyzed; for each program module 310 executed, its number m and the number q of the program module 310 that followed it are recorded;

d) for each program module m 310, a frequency of occurrence of it following program module m-1 310 is calculated;

e) based on the calculated frequencies a matrix of transition frequencies is formed.

The following matrix illustrates the transitions from a current program module m-1 (columns) to a next program module m (rows):

| m | 1 | 2 | . . . | m − 1 | m |
|---|---|---|---|---|---|
| 1 | X | p(2, 1) | p( . . ., 1) | p(m − 1, 1) | p(m, 1) |
| 2 | p(1, 2) | X | p( . . ., 2) | p(m − 1, 2) | p(m, 2) |
| : | | | X | | |
| m − 1 | | | | X | |
| m | | | | | X |

A list of all non-zero probability transitions and their probabilities can be stored for use in determining the next most appropriate program module 310 for mapping from a natural language utterance 102.

The simple Markov model can be enhanced to account for position relative (step) occurrences of specific program module 310 execution within a dialog. Given that a dialog is defined as a series of natural language utterances 102 and that the natural language utterances 102 are mapped to program modules 310 for execution, then the relative position of program modules 310 within that series can be a recorded for use in determining the next most appropriate program module 310 for mapping from a natural language utterance 102. The calculated frequencies of transition frequencies is formed (as in the simple Markov model) and additionally a vector of positional steps s relative to the dialog is recorded, so each matrix entry has the form p(m-1, m, s) for steps 1-n.

The following matrix illustrates the transitions from a current program module m-1 (columns) to a next program module m (rows) for dialogs with up to three steps s:

| m | 1 | 2 | . . . | m − 1 | m |
|---|---|---|---|---|---|
| 1 | X | p(2, 1, 2) | p( . . ., 1,, 1) | p(m − 1, 1, 1) | p(m, 1, 1) |
| | | p(2, 1, 2) | p( . . ., 1,, 2) | p(m − 1, 1, 2) | p(m, 1, 2) |
| | | p(2, 1, 3) | p( . . ., 1,, 3) | p(m − 1, 1, 3) | p(m, 1, 3) |
| 2 | p(1, 2, 1) | X | p( . . ., 2, 1) | p(m − 1, 2, 1) | p(m, 2, 1) |
| | p(1, 2, 2) | | p( . . ., 2, 2) | p(m − 1, 2, 2) | p(m, 2, 2) |
| | p(1, 2, 3) | | p( . . ., 2, 3) | p(m − 1, 2, 3) | p(m, 2, 3) |
| : | | | X | | |
| m − 1 | | | | X | |
| m | | | | | X |

A list of all non-zero probability transitions and their probabilities based on relative position within a dialog can be stored for use in determining the next most appropriate program module 310 for mapping from a natural language utterance 102. Analyzing successful mappings of natural language utterances 102 to program modules 310 does require more effort in training, but results in more accurate computer language understanding.

Further enhancements to the simple Markov model include identifying sets of related program modules 310 that are often executed in the same sequence and/or as a group. These groups of program modules 310 can be executed in different dialogs, but may only differ in the values of the program arguments values 330 that are passed. The groups that are identified as part of the dialog analysis can be labeled and recorded. Subsequent processing by the computer instruction generator 160 can draw on the recorded information to determine the next most appropriate program module 310 based upon the identified group that a current program module is in, as well as the probabilities of subsequently executing a next program module from the same group.

The use of the various Markov models in determining the next most appropriate program module 310 results in faster and more accurate selection. This results from the full selection set for the next program module 310 being reduced based upon, frequency, step-based frequency and/or grouping, from the full set of available program modules 310 to a smaller subset of more appropriate program modules 310.

Those of ordinary skill in the art should recognize that methods involved in a system providing computer understanding and instructions from natural language may be embodied in a computer program product that includes a computer usable medium. For example, such a computer usable medium can include a readable memory device, such as a solid state memory device, a hard drive device, a CD-ROM, a DVD-ROM, or a computer diskette, having stored computer-readable program code segments. The computer readable medium can also include a communications or transmission medium, such as a bus or a communications link, either optical, wired, or wireless, carrying program code segments as digital or analog data signals.

While the system has been particularly shown and described with references to particular embodiments, it will be understood by those of ordinary skill in the art that various changes in form and details may be made without departing from the scope of the invention encompassed by the appended claims. For example, the methods of the invention can be applied to various environments, and are not limited to the described environment. Additionally, various combinations of the Markov models can be combined to produce more and different probability-based data for use in determining the next most appropriate program module 310.

What is claimed is:

1. A method for providing computer understanding by generating computer instructions from a natural language dialog, comprising:
receiving a symbolic representation of a natural language utterance;
determining, by accessing a context sensitive system dictionary for a subject area, a subject area identifier based upon parsing the symbolic representation, the parsing producing parsed information;
determining, by accessing a context sensitive system subdictionary for a program module of the subject area, a module identifier based upon the determined subject area identifier and the parsed information;
determining, by accessing a context sensitive system subdictionary for an argument of the program module, an argument identifier based upon the determined module identifier and the parsed information;
determining, by accessing a context sensitive system subdictionary for a value of the argument, a value identifier based upon the determined argument identifier and the parsed information; and
producing computer instructions based upon the subject area identifier, module, the module identifier, the argument identifier and the value identifier, such that the natural language utterance is processed by the computer.

2. The method of claim 1 wherein the context sensitive system dictionary for the subject area further comprises a context sensitive system subdictionary for a sub-subject area.

3. The method of claim 1 wherein
determining a value identifier further comprises querying the computer system for a missing value identifier.

4. The method of claim 1 wherein
determining a subject area identifier further comprises querying a user of the computer system for a missing subject area identifier;
determining a module identifier further comprises querying a user of the computer system for a missing module identifier; and
determining a value identifier further comprises querying a user of the computer system for a missing value identifier.

5. The method of claim 1 wherein
determining a subject area identifier further comprises using a previously determined value for a missing subject area identifier;
determining a module identifier further comprises using a previously determined value for a missing module identifier; and
determining a value identifier further comprises using a previously determined value for a missing value identifier.

6. A method for determining an appropriate program module selection for processing a natural language dialog in a computer system for processing natural language, comprising:
capturing a set of successfully understood natural language dialogs and associated program modules used to produce computer understanding;
analyzing the captured program module information to determine a frequency of occurrence value for proceeding to a next program module from a current program module;
storing the frequency of occurrence values in a matrix; and
determining, using the matrix, the appropriate program module selection based on choosing program modules having non-zero frequency value entries in the matrix.

7. The method for claim 6 further comprising:
capturing a step associated with the program modules as executed within the natural language dialogs;
analyzing the captured program module information to determine a frequency of occurrence value, for each of the steps in the dialog, for proceeding to a next program module from a current program module;
storing the frequency of occurrence values and step information in a matrix; and
determining, using the matrix, the appropriate program module selection based on choosing program modules with matching step information and having non-zero frequency value entries in the matrix.

8. The method for claim 6 further comprising:
capturing grouping information for the program modules as executed within the natural language dialogs;
analyzing the captured program module information to determine a frequency of occurrence value, for each of the groupings, for proceeding to a next program module from a current program module;
storing the frequency of occurrence values and the grouping information in a matrix; and
determining, using the matrix, the appropriate program module selection based on choosing program module groupings having non-zero frequency value entries in the matrix.

9. An apparatus providing computer understanding by generating computer instructions from a natural language dialog, comprising:
a receiver receiving a symbolic representation of a natural language utterance;
a context sensitive subject area system dictionary used to determine a subject area identifier based upon parsing the symbolic representation, the parsing producing parsed information;
a context sensitive system program module subdictionary used to determine a module identifier based upon the determined subject area identifier and the parsed information;
a context sensitive argument system subdictionary used to determine an argument identifier based upon the determined module identifier and the parsed information;
a context sensitive value system subdictionary used to determine a value identifier based upon the determined argument identifier and the parsed information; and
computer instructions produced based upon the subject area identifier, module, the module identifier, the argument identifier and the value identifier, such that the natural language utterance is processed by the computer.

10. The apparatus of claim 9 wherein the context sensitive system dictionary for the subject area further comprises a context sensitive system subdictionary for a sub-subject area.

11. The apparatus of claim 9 wherein undetermined value identifiers are determined by querying the computer system for a missing value identifier.

12. The apparatus of claim 9 wherein:
undetermined subject area identifiers are determined by querying a user of the computer system for a missing subject area identifier;
undetermined module identifiers are determined by querying a user of the computer system for a missing module identifier; and
undetermined value identifiers are determined by querying a user of the computer system for a missing value identifier.

13. The apparatus of claim 9 wherein
undetermined subject area identifiers are determined using a previously determined value for a missing subject area identifier;
undetermined module identifiers are determined using a previously determined value for a missing module identifier; and
undetermined value identifiers are determined using a previously determined value for a missing value identifier.

14. An apparatus determining an appropriate program module selection for processing a natural language dialog in a computer system for processing natural language, comprising:
a set of successfully understood natural language dialogs and associated program modules used to produce computer understanding;
an analyzer analyzing the captured program module information to determine a frequency of occurrence value for proceeding to a next program module from a current program module;
a matrix storing the frequency of occurrence values; and
a logic unit determining, using the matrix, the appropriate program module selection based on choosing program modules having non-zero frequency value entries in the matrix.

15. The apparatus of claim 14 further comprising:
a step identifier, associated with the program modules as executed within the natural language dialogs;
an analyzer analyzing the captured program module information to determine a frequency of occurrence value, for each of the steps identified in the dialog, for proceeding to a next program module from a current program module;
a matrix storing the frequency of occurrence values and step information; and
a logic unit determining, using the matrix, the appropriate program module selection based on choosing program modules with matching step information and having non-zero frequency value entries in the matrix.

16. The apparatus of claim 14 further comprising:
a grouping identifier for the program modules as executed within the natural language dialogs;
an analyzer analyzing the captured program module information to determine a frequency of occurrence value, for each of the groupings, for proceeding to a next program module from a current program module;
a matrix storing the frequency of occurrence values and the grouping information; and
a logic unit determining, using the matrix, the appropriate program module selection based on choosing program module groupings having non-zero frequency value entries in the matrix.

17. An apparatus for providing computer understanding by generating computer instructions from a natural language dialog, comprising:
a means for receiving a symbolic representation of a natural language utterance;
a means for determining, by accessing a context sensitive system dictionary for a subject area, a subject area identifier based upon parsing the symbolic representation, the parsing producing parsed information;
a means for determining, by accessing a context sensitive system subdictionary for a program module of the subject area, a module identifier based upon the determined subject area identifier and the parsed information;
a means for determining, by accessing a context sensitive system subdictionary for an argument of the program module, an argument identifier based upon the determined module identifier and the parsed information;
a means for determining, by accessing a context sensitive system subdictionary for a value of the argument, a value identifier based upon the determined argument identifier and the parsed information; and
a means for producing computer instructions based upon the subject area identifier, module, the module identifier, the argument identifier and the value identifier, such that the natural language utterance is processed by the computer.

18. A computer program product comprising:
a computer usable medium for providing computer understanding by generating computer instructions from a natural language dialog;
a set of computer program instructions embodied on the computer usable medium, including instructions to:
receive a symbolic representation of a natural language utterance;
determine, by accessing a context sensitive system dictionary for a subject area, a subject area identifier based upon parsing the symbolic representation, the parsing producing parsed information;
determine, by accessing a context sensitive system subdictionary for a program module of the subject area, a module identifier based upon the determined subject area identifier and the parsed information;
determine, by accessing a context sensitive system subdictionary for an argument of the program module, an argument identifier based upon the determined module identifier and the parsed information;
determine, by accessing a context sensitive system subdictionary for a value of the argument, a value identifier based upon the determined argument identifier and the parsed information; and
produce computer instructions based upon the subject area identifier, module, the module identifier, the argument identifier and the value identifier, such that the natural language utterance is processed by the computer.

19. A computer data signal embodied in a carrier wave comprising a code segment for providing computer understanding by generating computer instructions from a natural language dialog, the code segment including instructions to:
receive a symbolic representation of a natural language utterance;
determine, by accessing a context sensitive system dictionary for a subject area, a subject area identifier based upon parsing the symbolic representation, the parsing producing parsed information;
determine, by accessing a context sensitive system subdictionary for a program module of the subject area, a module identifier based upon the determined subject area identifier and the parsed information;
determine, by accessing a context sensitive system subdictionary for an argument of the program module, an argument identifier based upon the determined module identifier and the parsed information;
determine, by accessing a context sensitive system subdictionary for a value of the argument, a value identifier based upon the determined argument identifier and the parsed information; and
produce computer instructions based upon the subject area identifier, module, the module identifier, the argument identifier and the value identifier, such that the natural language utterance is processed by the computer.
